(19) United States
(12) Patent Application Publication
(10) Pub. No.: US 2014/0059293 A1
(43) Pub. Date: Feb. 27, 2014

(54) METHOD FOR PROTECTING A GPT CACHED DISKS DATA INTEGRITY IN AN EXTERNAL OPERATING SYSTEM ENVIRONMENT

(71) Applicant: Samsung Electronics Co., Ltd., Suwon-si (KR)

(72) Inventor: Pradeep Bisht, Mountain View, CA (US)

(73) Assignee: Samsung Electronics Co., Ltd., Suwon-si (KR)

(21) Appl. No.: 13/967,219

(22) Filed: Aug. 14, 2013

Related U.S. Application Data
(63) Continuation-in-part of application No. 13/595,986, filed on Aug. 27, 2012.

(51) Int. Cl. G06F 12/08

(52) U.S. Cl. CPC G06F 12/0866; G06F 12/0848
USPC 711/113

(57) ABSTRACT

An invention is provided for protecting the data integrity of a cached storage device in an alternate operating system (OS) environment. The invention includes replacing a globally unique identifiers partition table (GPT) for a cached disk with a modified globally unique identifiers partition table (MGPT). The MGPT renders cached partitions on the cached disk inaccessible when the MGPT is used by an OS to access the cached partitions, while un-cached partitions on the cached disk are still accessible when the using MGPT. In normal operation, the data on the cached disk is accessed using information based on the GPT, which can be stored on a caching disk, generally via caching software. In response to receiving a request to disable caching, the MGPT on the cached disk is replaced with the GPT, thus rendering the all data on the formally cached disk accessible in an alternate OS environment where appropriate caching software is not present.

### CROSS REFERENCE TO RELATED APPLICATIONS

This application is a continuation-in-part of U.S. patent application Ser. No. 13/595,986, filed Aug. 27, 2012, entitled “Method For Protecting Storage Device Data Integrity In an External Operating Environment,” which is hereby incorporated by reference.

### BACKGROUND OF THE INVENTION

1. Field of the Invention

This invention relates generally to data integrity, and more particularly to protecting the data integrity of a GUID partition table based storage device in an alternate operating system environment.

2. Description of the Related Art

Caching has long been used in storage environments to enhance the performance of slower storage devices, such as disk drives. In caching, a smaller and faster storage medium is utilized to temporarily store and retrieve frequently used data, while the larger and typically slower mass storage medium is used for long term storage of data. One caching methodology is write-back caching, wherein data written to a disk is first stored in a cache and later written to the mass storage device, typically when the amount of data in cache reaches some threshold value or when time permits.

FIG. 1 is a block diagram showing an exemplary prior art computer system 100 having write back caching capability. The exemplary prior art computer system 100 includes a central processing unit (CPU) 102 in communication with system memory 104, a cache 106, and a target storage device 108. In addition, loaded into system memory 104 is caching software 110, which functions to facilitate write-back caching functionality on the computer system 100.

As mentioned previously, the cache 106 generally comprises a smaller, faster access storage than that used for the target storage device 108. Because of the enhance speed of the cache 106, reads and writes directed to the cache 106 are processed much faster than is possible using the target storage device 108. Write-back caching takes advantage of these differences by sending all write requests to the write-back cache 106 before later transferring the data to the target storage device 108.

For example, when the CPU 102 processes a write request to write data to the target storage device 108, the caching software 110 intercepts the write request and writes the data to the cache 106 instead. This data often is referred to as “dirty” data because it has not yet been written to the target storage device 108, and later becomes “clean” data when the data is later written to the target storage device 108. The caching software 110 provides a complete view of the target storage device 108 to the user. That is, when the CPU 102 processes a read request for the same data, the caching software 110 again intercepts the read request and determines whether the data is stored in cache memory. When the data is stored in cache memory, the CPU 102 reads the data from the cache 106, otherwise the CPU 102 reads the data from the target storage device 108.

As can be appreciated, at any point in time data can be stored in the cache 106 and not yet updated on the target storage device 108, and therefore the target storage device 108 may not have a complete and consistent copy of what then user believes is stored there. As a result, if the user decides to move the target storage device 108 to another operating system (OS) environment where caching software 110 is not present the data on the target storage device 108 may get corrupted and become useless.

For example, when a file is partially stored on the target storage device 108 and partially stored in the cache 106, the caching software 110 provides a complete view of the file and the user sees the file as being completely stored on the target device 108. However, if the user moves the target storage device 108 to another OS environment where caching software 110 is not present, the file on the target storage device 108 will not be complete. However, the user does not know whether the file is complete or not and may attempt to modify the file. When the target storage device 108 is later brought back to the original OS environment, data integrity problems occur.

Traditionally, this data integrity problem was addressed by having the user disable the caching software 110 prior to removing the target storage device 108 to another OS environment. When the caching software 110 is disabled, it flushes all the dirty data from the cache 106 ensuring the data on target storage device 108 is complete and clean. Now, when the target storage device 108 is taken to another OS environment, no data corruption will occur as a result of caching.

Unfortunately, users do not always remember to disable the caching software 110 prior to removing the target storage device 108 and moving it to another OS environment. As a result, a forgetful user can still corrupt the data on the target storage device 108 despite the cache flushing capabilities of the caching software 110 because they forget to disable the caching software 110 prior to moving the target storage device 108.

In view of the foregoing, there is a need for systems and methods for protecting the data integrity of storage devices in alternate OS environments. Ideally, the systems and methods should provide some protection even when the user forgets to disable the caching software prior to moving a cached storage device to an alternate OS environment.

### SUMMARY OF THE INVENTION

Broadly speaking, embodiments of the present invention address these needs by providing a process for protecting the data integrity of a cached storage device in an alternate OS environment. In one embodiment, a method for protecting data integrity of a disk in an alternate operating system (OS) environment is disclosed. The method includes replacing a globally unique identifiers partition table (GPT) for a cached disk with a modified globally unique identifiers partition table (MGPT). Importantly, the MGPT renders cached partitions on the cached disk inaccessible when the MGPT is used by an OS to access the cached partitions, while un-cached partitions on the cached disk are still accessible when using the MGPT. In normal operation, the data on the cached disk is accessed using information based on the GPT, generally via caching software.

To ensure cached partitions on the cached disk are inaccessible in alternate OS environments, partition entries in the MGPT for cached partitions have begin and end locations that are different than those stored in corresponding entries in the GPT for the cached disk. However, partition entries in the MGPT for un-cached partitions are the same as corresponding entries in the GPT for the cached disk, thus allowing un-cached partitions to remain accessible in alternate OS environments. The MGPT generally is stored on the cached disk in such a manner that the MGPT will be utilized by an OS to boot the cached disk in an alternate operating system (OS) environment. The GPT can be stored on a caching disk, which is utilized for write-back caching to store cached data for the cached disk. In addition, the GPT also is stored on the cached disk in a location other than a location of the MGPT, thus allowing full GPT reconstruction if the caching disk is somehow corrupted.

A further method for protecting data integrity of a disk in an alternate OS environment is disclosed in an additional embodiment of the present invention. Similar to above, the method includes replacing a GPT for a cached disk with a modified GPT (MGPT), wherein the MGPT renders cached partitions on the cached disk inaccessible when the MGPT is used by an OS to access the cached partitions, and wherein un-cached partitions on the cached disk are accessible when the MGPT is used by the OS to access the un-cached partitions. In normal operation, the data on the cached disk is accessed using information based on the GPT, generally via caching software. Then, in response to receiving a request to disable caching, the MGPT on the cached disk is replaced with the GPT. As above, partition entries in the MGPT for cached partitions have begin and end locations different than stored in corresponding entries in the GPT for the cached disk, and partition entries for un-cached partitions are the same as corresponding entries in the GPT for the cached disk. The GPT is stored both on a caching disk and on the cached disk in a location other than a location of the MGPT.

A computer program embodied on a computer readable medium for protecting data integrity of a disk in an alternate OS environment is disclosed in yet a further embodiment of the present invention. The computer program includes computer instructions that replace a GPT for a cached disk with a modified GPT (MGPT), wherein the MGPT renders cached partitions on the cached disk inaccessible when the MGPT is used by an OS to access the cached partitions, and wherein un-cached partitions on the cached disk are accessible when the MGPT is used by the OS to access the un-cached partitions. In addition, computer instructions are included that access the data on the cached disk using information based on the GPT. Similar to above, partition entries in the MGPT for cached partitions have begin and end locations different than stored in corresponding entries in the GPT for the cached disk, while partition entries for un-cached partitions are the same as corresponding entries in the GPT for the cached disk. The MGPT is stored on the cached disk in such a manner that the MGPT will be utilized by an OS to boot the cached disk in an alternate OS environment. In response to receiving a request to disable caching, computer instructions are included that that replace the MGPT on the cached disk with the GPT.

In this manner, the MGPT renders cached partitions of the cached disk inaccessible when the cached disk is moved to an alternate OS environment where the appropriate caching software is not present, while leaving un-cached partitions still accessible in the alternate OS environment. As a result, the user is reminded to return the cached disk back to the original computer system and disable the caching software in order to make the entire cached disk accessible in the alternate OS environment. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram showing an exemplary prior art computer system having write back caching capability;

FIG. 2 is a block diagram showing an exemplary computer system with a cached disk 208 having data integrity protection when the cached disk is moved to an alternate OS environment, in accordance with an embodiment of the present invention;

FIG. 3 is a diagram showing an exemplary GUID partition table (GPT) and a corresponding modified GUID Partition Table (MGPT), in accordance with an embodiment of the present invention;

FIG. 4 is a diagram showing a cached disk having plurality of partitions being accessed in an alternate OS environment not having the same caching software used in the original OS environment, in accordance with an embodiment of the present invention;

FIG. 5 is a block diagram showing an exemplary computer system wherein the cached disk has been fully updated and made complete in itself and can be safely accessed from an alternate OS where the caching software is not present, in accordance with an embodiment of the present invention;

FIG. 6 is a flowchart showing a method for protecting the data integrity of a cached disk when the disk is moved to an alternate OS environment, in accordance with an embodiment of the present invention; and

FIG. 7 is flowchart showing a method for rendering cached partitions on the cached disk accessible in alternate OS environments in response to receiving a request to disable caching, in accordance with an embodiment of the present invention.

### DETAILED DESCRIPTION OF THE PREFERRED EMBODIMENTS

An invention is disclosed for protecting the data integrity of a cached storage device using a globally unique identifiers (GUID) partition table in an alternate OS environment. In general, embodiments of the present invention utilize the GUID partition table of a disk to provide a mechanism for protecting data integrity of a cached disk. Because an OS attempts to access the disk via the GUID partition table, this procedure provides a mechanism to control what a user sees on the disk when in an alternate OS environment without requiring additional hardware or physically altering the system architecture.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

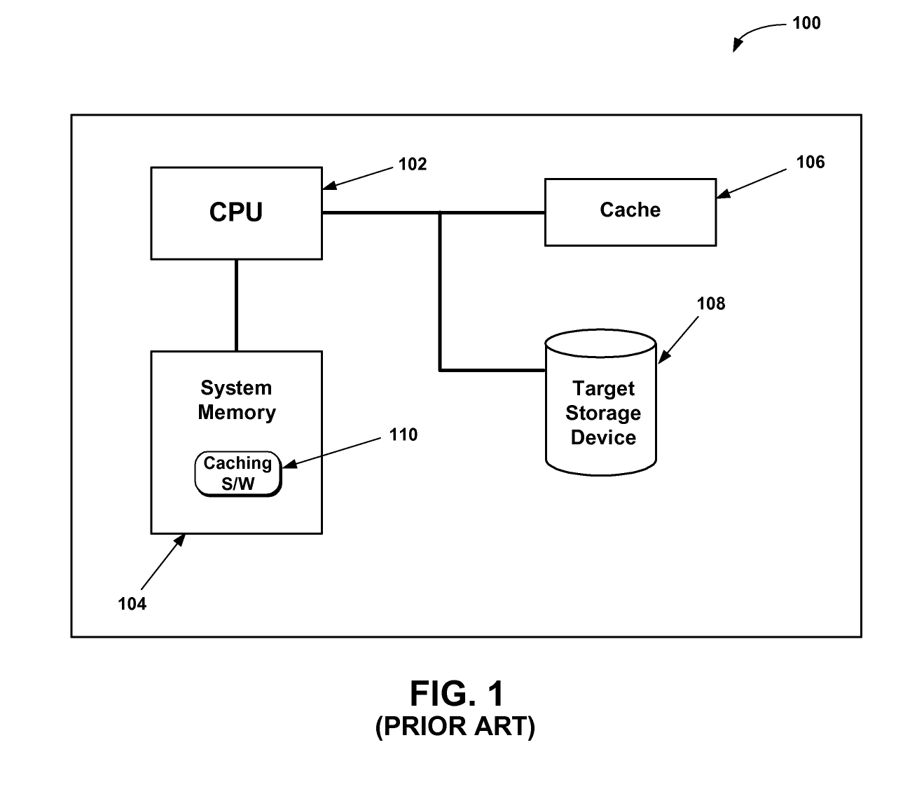

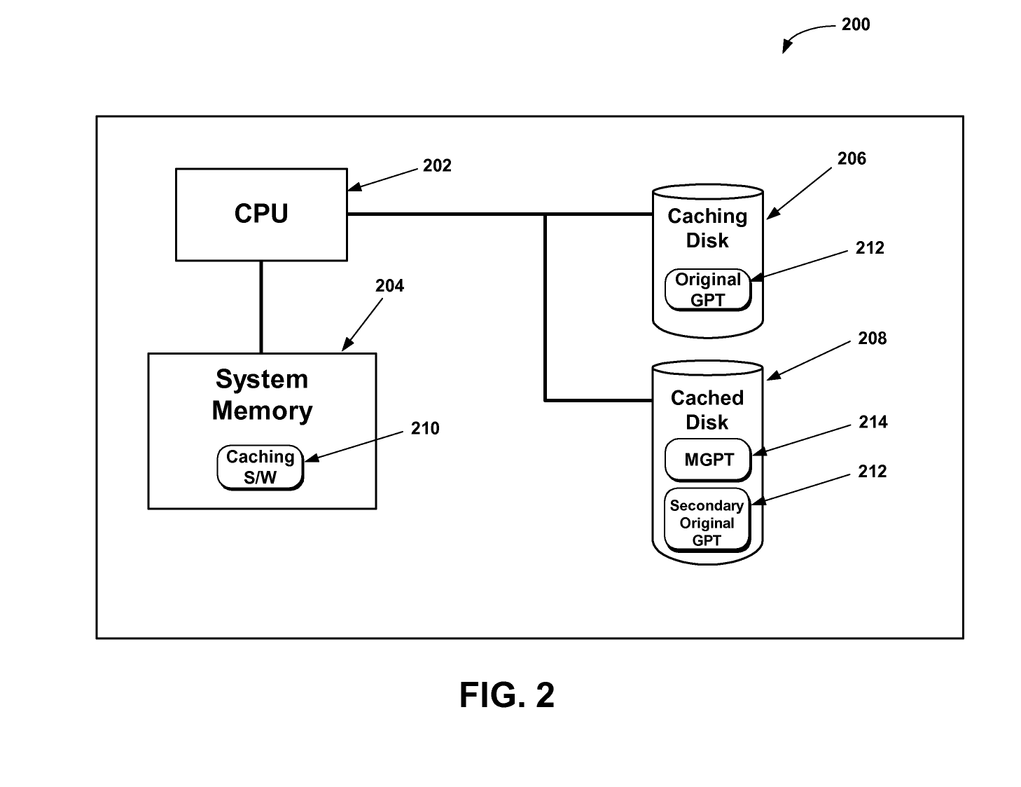

FIG. 1 was described in terms of the prior art. FIG. 2 is a block diagram showing an exemplary computer system 200 with a cached disk 208 having data integrity protection when the cached disk 208 is moved to an alternate OS environment, in accordance with an embodiment of the present invention. The computer system 200 includes a central processing unit (CPU) 202 connected to system memory 204, a caching disk 206, and a cached disk 208. In addition, caching software 210 is loaded into system memory 204 and functions to facilitate write-back caching functionality on the computer system 200.

The caching disk 206 generally is a smaller and faster access disk than that used for the cached disk 208. For example, the caching disk 206 can be a solid state drive (SSD) such as NAND flash based SSD or phase change memory (PCM). Because of the enhance speed of the caching disk 206, reads and writes directed to the caching disk 206 are processed much faster than is possible using the cached disk 208. Write-back caching takes advantage of these differences by sending all write requests to the caching disk 206 before later transferring the data to the cached disk 208. The caching software 210 provides a complete view of the cached disk 208, so the user always sees a complete view of the cached disk 208, regardless of whether or not some data is actually stored on the caching disk 206.

During normal operation, when the CPU 202 processes a write request to write data to the cached disk 208, the caching software 210 intercepts the write request and writes the data to the caching disk 206. This data often is referred to as “dirty” data because it has not yet been written to the cached disk 208, and later becomes “clean” data when it is later written to the cached disk 208. When the CPU 202 processes a read request for the same data, the caching software 210 again intercepts the read request and determines whether the data is located in cache memory. When the data is stored in cache memory, the CPU 202 reads the data from the caching disk 206, otherwise the CPU 202 reads the data from the cached disk 208.

As mentioned above, if the user decides to move a cached disk 208 to another OS environment without the same caching software 210, the data on the cached disk may get corrupted and become useless. Embodiments of the present invention address this issue by replacing the actual GUID partition table of the cached disk 208 with a modified GUID partition table (MGPT) 218, which renders the cached contents of the cached disk 208 inaccessible when moved to an alternate OS environment.

In a BIOS system, the first code executed by the CPU 202 during system startup is the system BIOS, which sets up the hardware for the computer system 200 and loads the operating system. The system BIOS then identifies a designated boot device, such as the cached disk 208 and attempts to load the operating system (OS) software that further controls the computer system 200. In newer systems that utilize Unified Extensible Firmware Interface (UEFI) standard, this function is provided via the UEFI using a GUID partition table.

The first sector 0 of a disk using a GUID partition table (GPT) is reserved for a protected MBR to support booting BIOS based systems from the GPT disk. The layout and partition information to access a GPT disk is stored in sectors 1 to 33 of the disk. These beginning sectors are called the GUID partition table. Embodiments of the present invention replace the original GUID partition table for the disk with a modified GUID partition table. In one embodiment, the original GPT 212 for the cached disk 208 is replaced with a modified GUID partition table (MGPT) 214. The original GPT 212 is saved to another location on the cached disk 208, such as towards the end of the cached disk 208. For example, UEFI standard specifies that a Secondary GUID partition table that duplicates the Primary GUID partition table be located at the end of the disk. Hence, as illustrated in FIG. 2, the original GUID partition table 212 is stored on the cached disk 208 as the Secondary original GUID partition table 212. In addition, the original GPT 212 is saved on the caching disk 206.

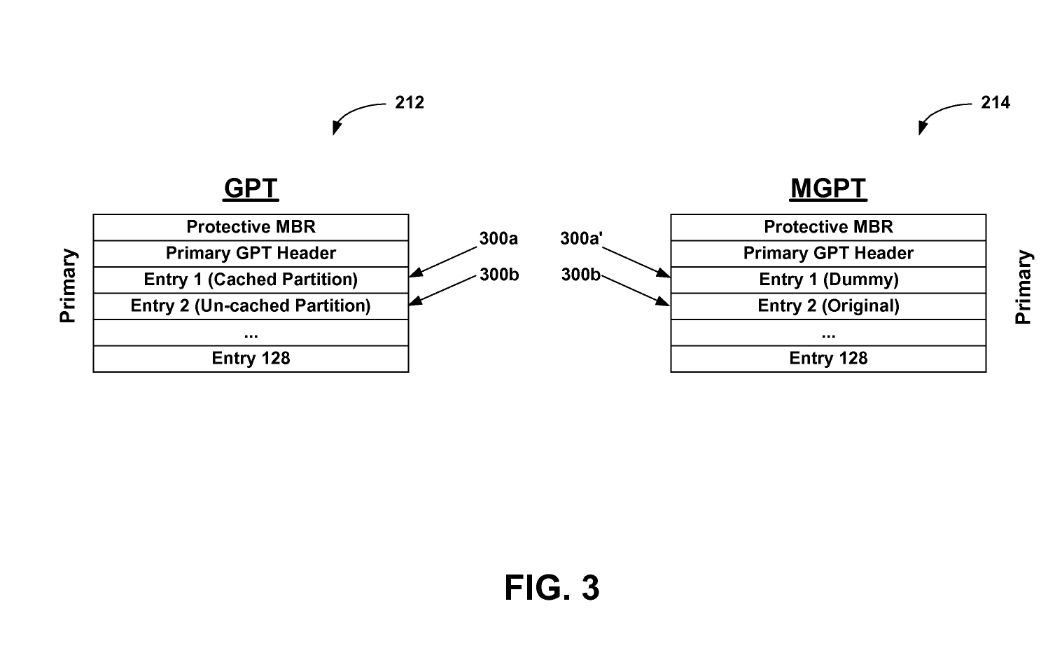

FIG. 3 is a diagram showing an exemplary GUID partition table (GPT) 212 and a corresponding modified GUID Partition Table (MGPT) 214, in accordance with an embodiment of the present invention. As shown in FIG. 3, the first logical sector is reserved for a protected MBR to support booting BIOS based systems from the GPT disk. Following the Protective MBR sector are the Primary GPT Header and partition table entries. Embodiments of the present invention modify the entries for cached partitions, while leaving un-cached entries intact. For example, in FIG. 3, entry 1 300a defines a cached partition while entry 2 300b defines an un-cached partition. Embodiments of the present invention replace the data for cached entry 1 300a with dummy data for entry 1 300a′ in the MGPT 214. That is, the partition begin and end location data for the entry 1 300a′ in the MGPT 214 is different from the partition begin and end location data for entry 1 300a in the original GPT 212.

However, embodiments of the present invention do not modify the entries for un-cached partitions. For example, in FIG. 3, entry 2 300b defines an un-cached partition. Thus, embodiments of the present invention do not replace the data for un-cached entry 2 300b in the MGPT 214. That is, the partition begin and end location data for the entry 2 300b in the MGPT 214 is the same as the partition begin and end location data for entry 2 300b in the original GPT 212. Thus, an OS using the MGPT 214 will have access to un-cached partitions, while not have access to cached partitions.

In this manner, if the cached disk 208 is moved to an alternate OS environment without first disabling the caching software 210, the new computer system will not be able to access any of the cached partition data on the cached disk 208. This results from the alternate OS loading the MGTP 214 with the dummy partition entry data 300a′, which stores dummy (different from the original) layout and partition information for cached partitions. As a consequence, the cached partitions on the cached disk 208 will be inaccessible without the proper caching software 210.

Referring back to FIG. 2, the original GPT 212 for the cached disk 208 is stored both on the caching disk 206 and at a predefined new location on the cached disk 208, for example near the end of the cached disk 208. However, it should be noted that the GPT 212 can be stored in any location other than LBAs 1-33 and un-cached partitions of the cached disk 208. For example, the GPT 212 can be stored at another non-boot sector of the cached disk 208, with a pointer (LBA) to the address of the GPT 212 stored on the caching disk 206. The original GPT 212 includes all the proper partition entry data for the cached disk 208. In general, the caching software 210 can keep the GPT 212 current during normal operation.

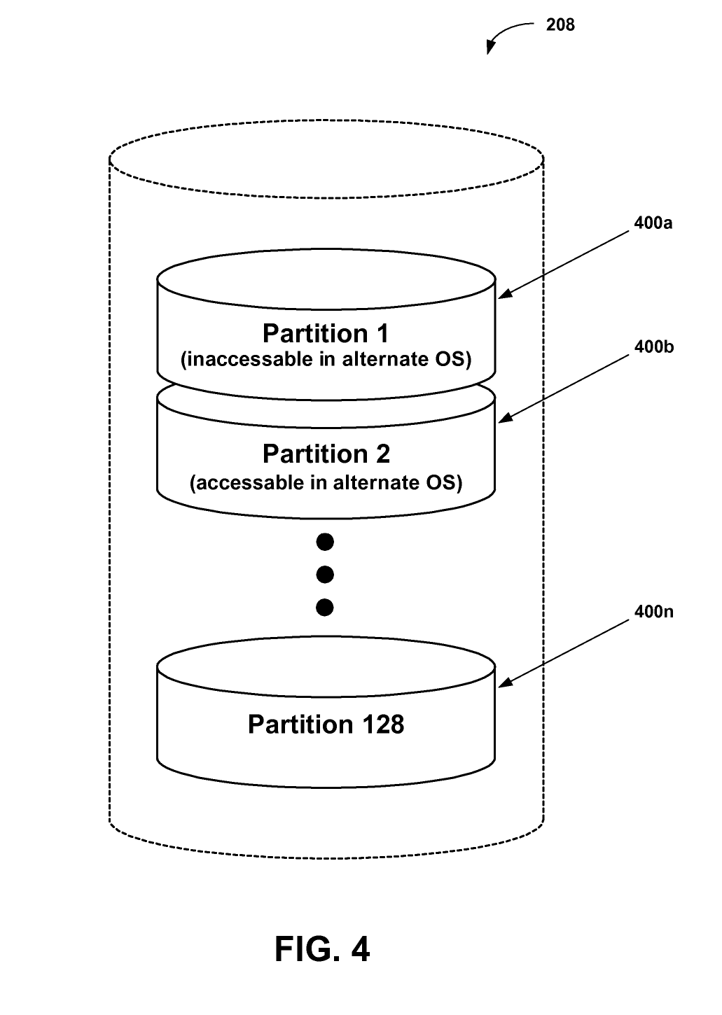

FIG. 4 is a diagram showing a cached disk 208 having plurality of partitions 400a-400n being accessed in an alternate OS environment not having the same caching software used in the original OS environment, in accordance with an embodiment of the present invention. The partitions 400a-400b illustrated in FIG. 4 correspond to the GPT 212 partition entries 300a-300b and MGPT 214 partition entries 300a′-300b. For example, partition 1 400a is a cached partition and corresponds to partition entry 300a, while partition 2 400b is an un-cached partition and corresponds to partition entry 300b.

When the cached disk 208 is moved to an alternate OS environment not having the same caching software used in the original OS environment, the MGPT 214 allows a user to access un-cached partition 2 400b on the cached disk 208. However, the MGPT 214 renders the cached partition 1 400a of the cached disk 208 inaccessible when the cached disk 208 is moved to the alternate OS environment not having the same caching software used in the original OS environment. As a result, the user is reminded to return the cached disk 208 back to the original computer system and disable the caching software 210 in order to make the cached partition data on the cached disk 208 accessible in the alternate OS environment. To restore the cached disk 208, embodiments of the present invention flush the caching disk 206 and replace the MGPT 214 on the cached disk 208 with the original GPT 212, which has been kept current.

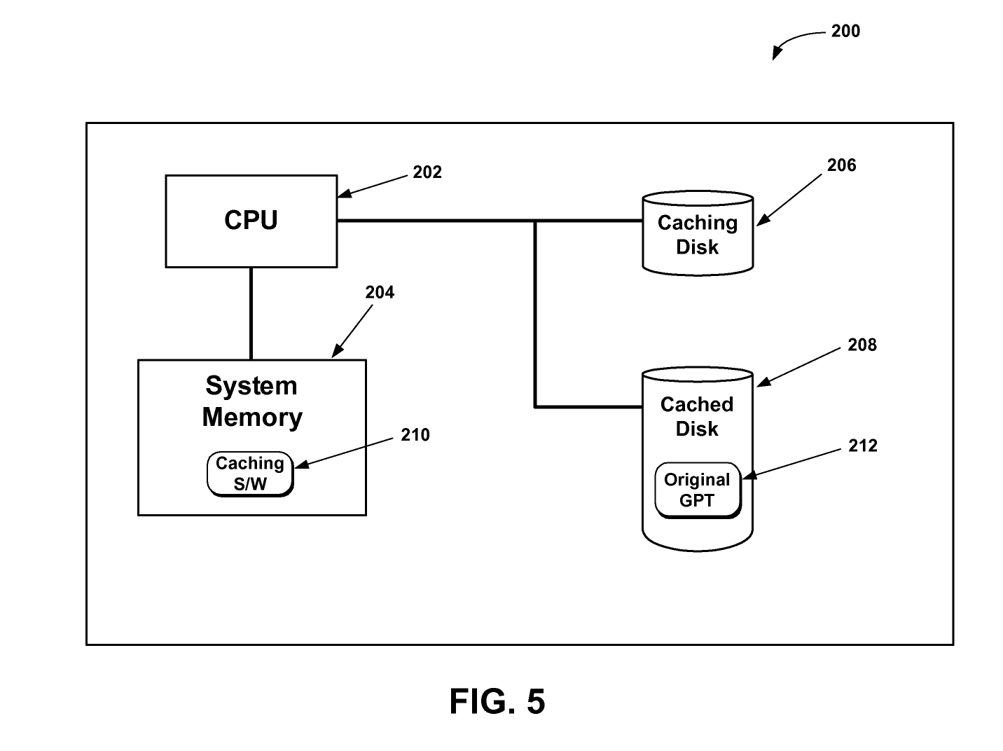

FIG. 5 is a block diagram showing an exemplary computer system 200 wherein the cached disk 208 has been fully updated and made complete in itself and can be safely accessed from an alternate OS where the caching software is not present, in accordance with an embodiment of the present invention. The computer system 200 includes a CPU 202 connected to system memory 204, a caching disk 206, and a cached disk 208. In addition, caching software 210 is loaded into system memory 204 and functions to facilitate write-back caching functionality on the computer system 200. As mentioned above, the caching software 210 provides a complete view of the cached disk 208 to the OS, so the user always sees a complete view of the cached disk 208, regardless of whether or not some data is actually stored on the caching disk 206 instead of on the cached disk 208.

As discussed above, if the user decides to move a cached disk 208 to an alternate OS environment where the same caching software 210 is not present, the modified GUID partition table renders the cached partitions of the cached disk 208 inaccessible when the modified GUID partition table is used by the alternate OS environment to access the data on the cached disk 208.

Thus, to move the cached disk 208 to an alternate OS environment, the user should disable disk caching for the cached disk 208 by sending a command to disable caching to the caching software 210. In response to receiving a request to disable caching for the cached disk 208, the caching software 210 prepares the cached disk 208 for safe removal and use in the alternate OS environment.

In particular, the caching software 210 flushes the cached data for the cached disk 208 by ensuring that all the dirty data for the cached disk 208 still on the caching disk 206 is written to the cached disk 208. In addition, the caching software 210 ensures the original GPT 212 for the cached disk 208 is consistent and complete for the cached disk 208 by performing any updates to the GPT 212 as necessary. Then the caching software 210 writes the updated GPT 212 to the cached disk 208. In the example of FIG. 5, this is done by replacing the MGPT 214 stored on the cached disk 208 with the updated GPT 212 for the cached disk 208. Thereafter, all partitions on the cached disk 208 are complete. That is, the cached disk 208 is complete in itself and can be accessed safely from an alternate OS where the caching software 210 is not present.

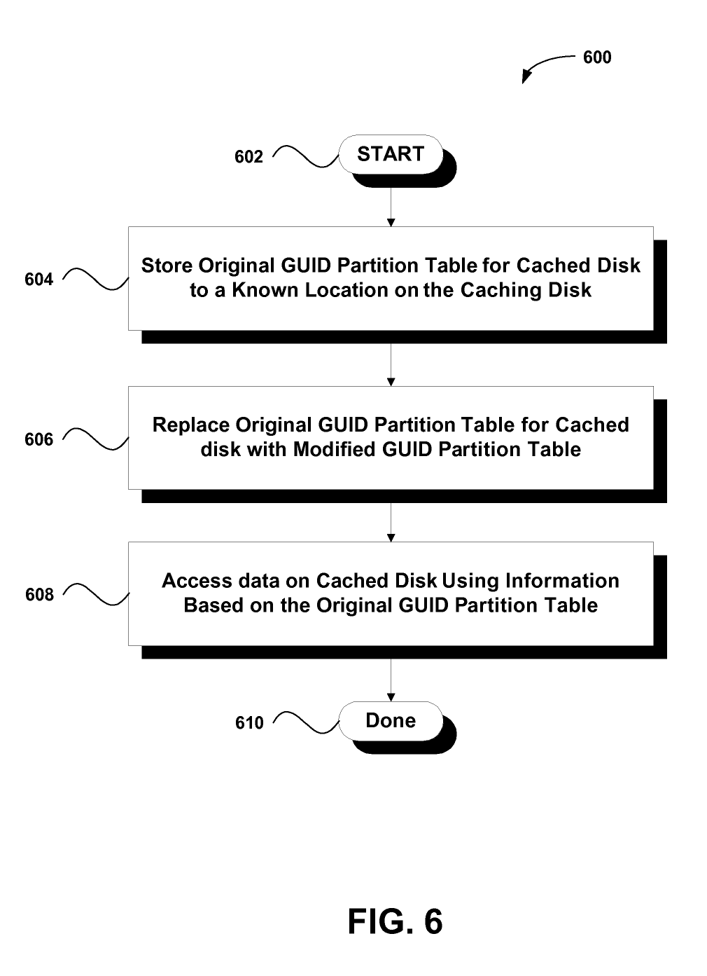

FIG. 6 is a flowchart showing a method 600 for protecting the data integrity of a cached disk when the disk is moved to an alternate OS environment, in accordance with an embodiment of the present invention. In an initial operation 602, preprocess operations are performed. Preprocess operations can include, for example, loading caching software into system memory, and other preprocess operations that will be apparent to those skilled in the art with the hindsight acquired from a careful reading of the present disclosure.

In operation 604, the original GUID partition table for the cached disk is stored in a known location other than sectors 1-33 and un-cached partitions of the cached disk. Turing to FIG. 2, when the caching software 210 is first installed, and anytime the caching software 210 is newly enabled for a disk to be cached, the original GUID partition table for the cached disk 208 is read and stored in a known location other than sectors 1-33 and un-cached partitions of the cached disk 208. One embodiment of the present invention reads the original GPT for the cached disk and stores the original GPT in a known location other than sectors 1-33 and un-cached partitions of the cached disk. For example, in FIG. 2 the original GPT 212 for the cached disk 208, is stored on the caching disk 206 and on the cached disk 208 in a known location other than sectors 1-33 and un-cached partitions.

Referring back to FIG. 6, the original GUID partition table for the cached disk is replaced with a modified GUID partition table, in operation 606. As mentioned above, the modified GUID partition table renders cached partitions on the disk inaccessible when the modified GUID partition table is used by an OS to access the data. Turning to FIG. 2, embodiments of the present invention replace the copy of the GPT 212 on the cached disk with a MGPT 214. As such, when the cached disk is accessed via an alternate OS environment without the same caching software 210, the OS will attempt to access the cached disk using the MGPT 214. As a result, cached partitions on the cached disk 208 will be inaccessible to the alternate OS, while un-cached partitions on the cached disk 208 will remain accessible in the alternate OS environment.

In operation 608 of method 600, the data on the cached disk is accessed using information based on the original GUID partition table. That is, during normal operation, the caching software 210 intercepts all request to access data on the cached disk 208 in order to perform write-back caching using the caching disk 206. This is accomplished using information based on the original GUID partition table, which can be updated as data is updated on the caching disk 206 and the cached disk 208.

Post process operations are performed in operation 610. Post process operations can include, for example, handling read and write request, committing dirty data to the cached disk when time permits, and further post process operations that will be apparent to those skilled in the art with the hindsight afforded after a careful reading of the present disclosure.

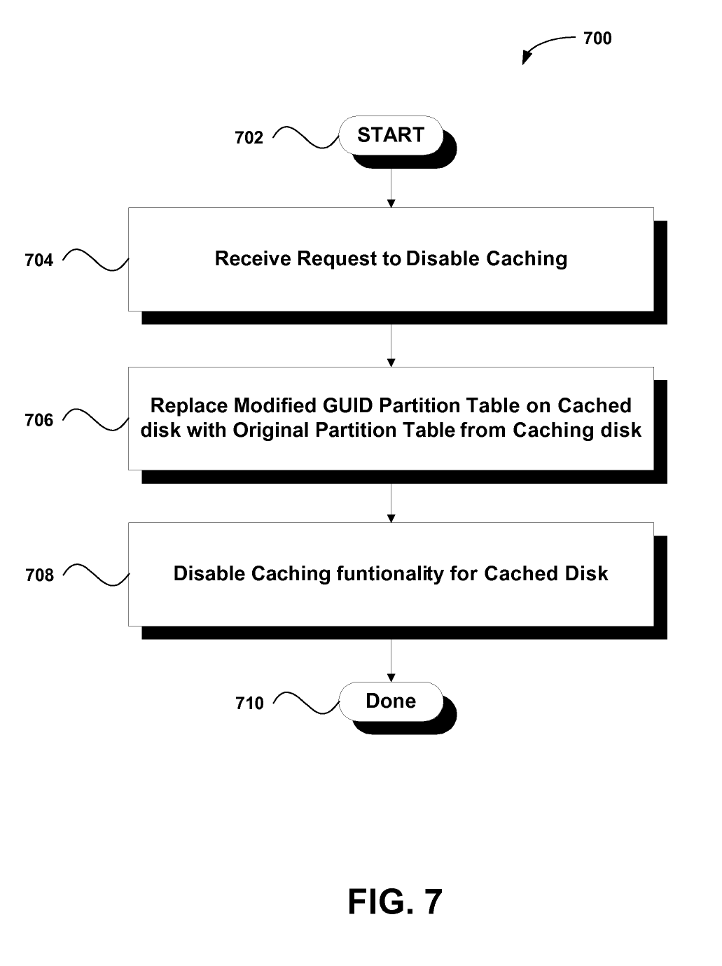

FIG. 7 is flowchart showing a method 700 for rendering cached partitions on the cached disk accessible in alternate OS environments in response to receiving a request to disable caching, in accordance with an embodiment of the present invention. In an initial operation 702, preprocess operations are performed. Preprocess operations can include, for example, providing write-back caching functionality for the cached disk, and other preprocess operations that will be apparent to those skilled in the art with the hindsight afforded after a careful reading of the present disclosure.

In operation 704, a request to disable caching is received. When a user wishes to move the cached disk to an alternate OS environment, the user should first disable caching for the cached disk in order to ensure the data stored on the cached disk is fully updated and clean. As will be described in greater detail below, disabling caching for the cached disk triggers the caching software to ensure the disk is fully updated and complete and able to be safely accessed from an alternate OS where the caching software is not present.

In response to receiving the request to disable caching, the modified GUID partition table on the cached disk is replaced with the original partition table for the cached disk, which has been kept up to date, in operation 706. This can be performed by replacing the MGPT on the cached disk with a fully updated GPT for the cached disk. Turing to FIG. 5, in response to receiving a request to disable caching for the cached disk 208, the caching software 210 prepares the cached disk 208 for safe removal and use in the alternate OS environment. Hence, the caching software 210 flushes the cached data for the cached disk 208 by ensuring that all the dirty data for the cached disk 208 still on the caching disk 206 is written to the cached disk 208. In addition, the caching software 210 ensures the original GUID partition table 212 for the cached disk 208 is consistent and complete for the cached disk 208 by performing any updates to the GUID partition table 212 as necessary. Then the caching software 210 writes the updated GUID partition table 212 to the cached disk 208. In the example of FIG. 5, this is done by replacing the MGPT 214 stored on the cached disk 208 with the GPT 212 for the cached disk 208. Thereafter, the data on the cached disk 208 is complete. That is, the cached disk 208 is complete in itself and can be accessed safely from an alternate OS where the caching software 210 is not present.

Referring back to FIG. 7, the caching functionality of the cached disk is disabled in operation 708. Once the caching software prepares the cached disk for safe removal and use in the alternate OS environment, caching functionality for the cached disked is disabled and the formally cached disk can be removed to an alternate OS environment and safely accessed. Post process operations are performed in operation 710. Post process operations can include, for example, enabling caching for other devices, removing the formally cached disk from the system, and other post process operations that will be apparent to those skilled in the art with the hindsight afforded after a careful reading of the present disclosure.

Embodiments of the present invention can be utilized in any storage environment where more than one disk is involved to provide the complete view of the storage sub-system. For example, embodiments of the present invention can be utilized in a RAID environment where multiple drives are used to store data. In RAID, the RAID software can be used to provide a complete view of the logical device the RAID represents. However, the individual disks of the RAID array can each have their GUID partition table replaced with a modified GUID partition table that renders the data stored on the disk inaccessible when the disk is moved to an alternate OS environment where the RAID software is not present. In this manner, the integrity of the data on the individual RAID disks can be protected should any disk be mistakenly moved to an alternate OS environment.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for protecting data integrity of a disk in an alternate operating system (OS) environment, comprising:
replacing a globally unique identifiers partition table (GPT) for a cached disk with a modified globally unique identifiers partition table (MGPT), wherein the MGPT renders cached partitions on the cached disk inaccessible when the MGPT is used by an OS to access the cached partitions, and wherein un-cached partitions on the cached disk are accessible when the MGPT is used by the OS to access the un-cached partitions; and
accessing the data on the cached disk using information based on the GPT.

2. A method as recited in claim 1, wherein partition entries in the MGPT for cached partitions have begin and end locations different than stored in corresponding entries in the GPT for the cached disk.

3. A method as recited in claim 2, wherein partition entries in the MGPT for un-cached partitions are the same as corresponding entries in the GPT for the cached disk.

4. A method as recited in claim 2, wherein the MGPT is stored on the cached disk in such a manner that the MGPT will be utilized by an OS to boot the cached disk in an alternate operating system (OS) environment.

5. A method as recited in claim 1, further comprising replacing the MGPT on the cached disk with the GPT in response to receiving a request to disable caching.

6. A method as recited in claim 1, wherein the GPT is stored on a caching disk, wherein the caching disk is utilized for write-back caching to store cached data for the cached disk.

7. A method as recited in claim 6, wherein the GPT also is stored on the cached disk in a location other than a location of the MGPT.

8. A method for protecting data integrity of a disk in an alternate operating system (OS) environment, comprising:
replacing a globally unique identifiers partition table (GPT) for a cached disk with a modified globally unique identifiers partition table (MGPT), wherein the MGPT renders cached partitions on the cached disk inaccessible when the MGPT is used by an OS to access the cached partitions, and wherein un-cached partitions on the cached disk are accessible when the MGPT is used by the OS to access the un-cached partitions;
accessing the data on the cached disk using information based on the GPT; and
replacing the MGPT on the cached disk with the GPT in response to receiving a request to disable caching.

9. A method as recited in claim 8, wherein partition entries in the MGPT for cached partitions have begin and end locations different than stored in corresponding entries in the GPT for the cached disk.

10. A method as recited in claim 9, wherein partition entries in the MGPT for un-cached partitions are the same as corresponding entries in the GPT for the cached disk.

11. A method as recited in claim 9, wherein the MGPT is stored on the cached disk in such a manner that the MGPT will be utilized by an OS to boot the cached disk in an alternate operating system (OS) environment.

12. A method as recited in claim 8, wherein the GPT is stored on a caching disk, wherein the caching disk is utilized for write-back caching to store cached data for the cached disk.

13. A method as recited in claim 8, wherein the GPT also is stored on the cached disk in a location other than a location of the MGPT.

14. A computer program embodied on a computer readable medium for protecting data integrity of a disk in an alternate operating system (OS) environment, comprising:
computer instructions that replace a globally unique identifiers partition table (GPT) for a cached disk with a modified globally unique identifiers partition table (MGPT), wherein the MGPT renders cached partitions on the cached disk inaccessible when the MGPT is used by an OS to access the cached partitions, and wherein un-cached partitions on the cached disk are accessible when the MGPT is used by the OS to access the un-cached partitions; and
computer instructions that access the data on the cached disk using information based on the GPT.

15. A computer program as recited in claim 14, wherein partition entries in the MGPT for cached partitions have begin and end locations different than stored in corresponding entries in the GPT for the cached disk.

16. A computer program as recited in claim 15, wherein partition entries in the MGPT for un-cached partitions are the same as corresponding entries in the GPT for the cached disk.

17. A computer program as recited in claim 14, wherein the MGPT is stored on the cached disk in such a manner that the MGPT will be utilized by an OS to boot the cached disk in an alternate operating system (OS) environment.

18. A computer program as recited in claim 14, further comprising computer instructions that replace the MGPT on the cached disk with the GPT in response to receiving a request to disable caching.

19. A computer program as recited in claim 14, wherein the GPT is stored on a caching disk, wherein the caching disk is utilized for write-back caching to store cached data for the cached disk.

20. A computer program as recited in claim 14, wherein the GPT is stored on the disk in a location other than a location of the MGPT.
